(19) United States
(12) Patent Application Publication
(10) Pub. No.: US 2026/0172092 A1
(43) Pub. Date: Jun. 18, 2026

(54) CHANNEL STATE INFORMATION REPORTING FOR SINGLE-USER AND MULTI-USER MULTIPLE INPUT MULTIPLE OUTPUT

(71) Applicant: Apple Inc., Cupertino, CA (US)

(72) Inventors: Ghaith N. Hattab, Santa Clara, CA (US); Louay Jalloul, San Jose, CA (US)

(73) Assignee: Apple Inc., Cupertino, CA (US)

(21) Appl. No.: 19/356,983

(22) Filed: Oct. 13, 2025

Related U.S. Application Data
(60) Provisional application No. 63/733,995, filed on Dec. 13, 2024.

(51) Int. Cl. H04B 7/06; H04B 7/0452; H04W 72/23

(52) U.S. Cl. CPC H04B 7/0626; H04B 7/0452; H04W 72/23

(57) ABSTRACT

The present application relates to channel state information (CSI) feedback to assist the network in selecting between single-user (SU)-multiple input multiple output (MIMO) and multiple user (MU)-MIMO operation. A user equipment (UE) determines respective performance metrics for SU-MIMO and MU-MIMO and generates one or more rank offsets based on a difference between the performance metrics. The UE determines a rank indicator (RI) to report in CSI feedback based on the one or more rank offsets.

### CROSS-REFERENCE TO RELATED APPLICATION

This application claims priority to U.S. Provisional Patent Application No. 63/733,995, entitled “CHANNEL STATE INFORMATION REPORTING FOR SINGLE-USER AND MULTI-USER MULTIPLE INPUT MULTIPLE OUTPUT,” filed on Dec. 13, 2024, which is herein incorporated by reference in its entirety for all purposes.

### BACKGROUND

In Third Generation Partnership (3GPP) cellular networks, multiple input, multiple output (MIMO) can be used to increase network throughput and improve user experience. MIMO systems typically rely on channel state information (CSI) feedback from the user equipment (UE) to determine a configuration for a transmission, such as the number of spatial streams (layers) and precoding. The network may schedule single-user (SU)-MIMO or multi-user (MU)-MIMO over a given set of time-frequency resources.

### BRIEF DESCRIPTION OF THE DRAWINGS

FIG. 1 illustrates an example of a network environment in accordance with some embodiments.

FIG. 2 illustrates an example procedure for rank selection, in accordance with some embodiments.

FIG. 3 illustrates an example procedure to determine one or more rank offsets in accordance with some embodiments.

FIG. 4 illustrates an example of an operational flow/algorithmic structure for rank selection with a rank offset, in accordance with some embodiments.

FIG. 5 illustrates another example of an operational flow/algorithmic structure for rank selection with a rank offset, in accordance with some embodiments.

FIG. 6 illustrates another example of an operational flow/algorithmic structure for rank selection with a rank offset in accordance with some embodiments.

FIG. 7 illustrates an example of receive components in accordance with some embodiments.

FIG. 8 illustrates an example of a UE in accordance with some embodiments.

FIG. 9 illustrates an example of a base station in accordance with some embodiments.

### DETAILED DESCRIPTION

Embodiments of the present disclosure relate to, among other things, CSI feedback to assist the network in selecting between SU-MIMO and MU-MIMO. In an example, a user equipment (UE) determines respective performance metrics (e.g., spectral efficiencies and/or another suitable metric) for SU-MIMO and MU-MIMO and generates one or more rank offsets based on a difference between the performance metrics. The UE determines a rank indicator (RI) to report in CSI feedback based on the one or more rank offsets. The rank offsets may bias the RI toward a higher rank when the performance metric for SU-MIMO (scheduled with higher rank) is better than the performance metric for MU-MIMO (scheduled with lower rank) and/or may bias the RI toward a lower rank when the performance metric for MU-MIMO (scheduled with lower rank) is better than the performance metric for SU-MIMO (scheduled with higher rank).

In the interest of clarity of explanation, various embodiments of the present disclosure are described in connection with a new radio (NR) fifth generation (5G) cellular network. However, the embodiments may not be limited as such and can apply to other types of wireless networks including, for instance, fourth generation (4G) cellular networks and/or sixth generation (6G) cellular networks.

The following detailed description refers to the accompanying drawings. The same reference numbers may be used in different drawings to identify the same or similar elements. In the following description, for purposes of explanation and not limitation, specific details are set forth, such as particular structures, architectures, interfaces, techniques, etc. in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrase “A or B” means (A), (B), or (A and B).

The following is a glossary of terms that may be used in this disclosure.

The term “circuitry” as used herein refers to, is part of, or includes hardware components, such as an electronic circuit, a logic circuit, a processor (shared, dedicated, or group) or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, a programmable system-on-a-chip (SoC)), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” “or “processing circuitry” as used herein refers to, is part of, or includes circuitry capable of carrying out a set of arithmetic or logical operations, and/or recording, storing, and/or transferring digital data. The term “processor circuitry” and “processing circuitry” may refer to an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, network interface cards, or the like.

The term “user equipment” or “UE” as used herein refers to a device with radio communication capabilities and may describe a remote user of network resources in a communications network. The term “user equipment” or “UE” may be considered synonymous to, and may be referred to as, client, device, mobile, mobile device, mobile terminal, user terminal, mobile unit, mobile station, mobile user, subscriber, user, remote station, access agent, user agent, receiver, radio equipment, reconfigurable radio equipment, reconfigurable mobile device, etc. Furthermore, the term “user equipment” or “UE” may include any type of wireless/wired device or any computing device including a wireless communications interface. The UE can communicate with another UE or a network and the UE may be integrated with other devices and/or systems (e.g., in a vehicle).

The term “base station” as used herein refers to a device with radio communication capabilities, that is a device of a communications network (or, more briefly, network), and that may be configured as an access node in the communications network. The logical functionality and/or physical deployment of the base station may be distributed among various units (e.g., Central Unit (CU), Distributed Unit (DU), Remote Unit (RU), etc.) within a radio access network (RAN). A UE's access to the communications network may be managed at least in part by the base station, whereby the UE connects with the base station to access the communications network. Depending on the radio access technology (RAT), the base station can be referred to as a gNodeB (gNB), eNodeB (eNB), access point, repeater on a communications satellite, etc.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated. Additionally, the term “link” as used herein refers to a connection between two devices for the purpose of transmitting and receiving information.

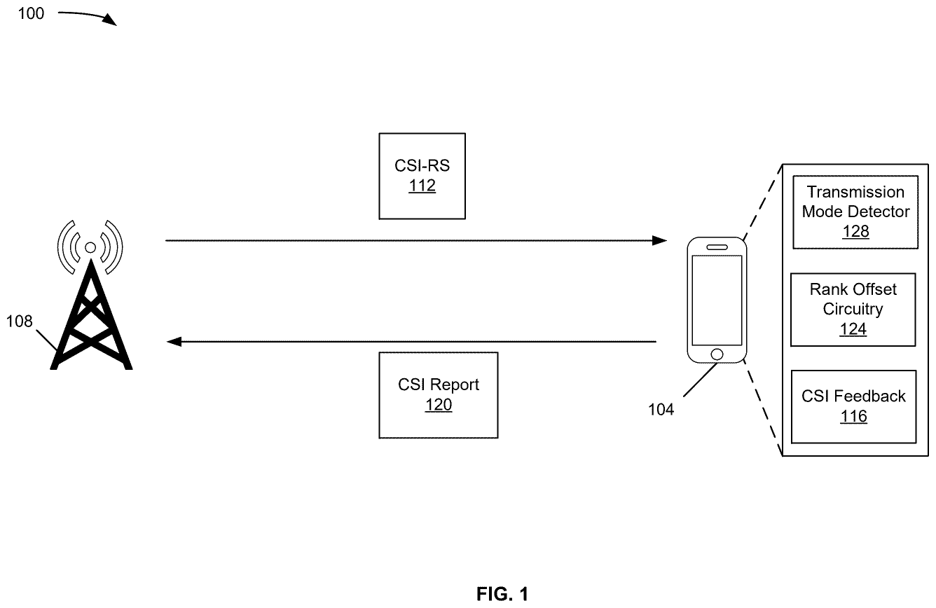

FIG. 1 illustrates a network environment 100, in accordance with some embodiments. The network environment 100 may include a UE 104 and a base station 108. The base station 108 provides a wireless access cell, for example, a Third-Generation Partnership Project (3GPP) New Radio (NR) cell, through which the UE 104 may communicate with the gNB. The base station 108 may include a set of transmission and reception points (TRPs). The UE 104 and the base station 108 may communicate over an interface compatible with 3GPP technical specifications, such as those that define Fifth-Generation (5G) NR system standards, Sixth-Generation (6G) standards, or the like.

Operations described herein as performed by a device (for example, UE 104 base station 108) may be fully, substantially, or partially performed by any logical or physical components of the device (e.g., transmitter, receiver, modem, application processor, processing circuitry, etc.) Additionally, operations described herein as performed by “the network” may be performed by a device of the access network (e.g., base station 108), a device of the core network, and/or components thereof.

As discussed further herein, the base station 108 can send a CSI-reference signal (CSI-RS) 112 to the UE 104. The UE 104 generates CSI feedback 116 based on the CSI-RS 112. The CSI feedback 116 may be in accordance with CSI configuration information received from the base station 108 (e.g., via radio resource control (RRC) signaling). The UE 104 transmits a CSI report 120 to the base station 108 that includes the CSI feedback 116. The CSI report 120 and/or CSI-RS 112 may be periodic or aperiodic (e.g., dynamically triggered).

The UE 104 may generate a rank indicator (RI) of the CSI feedback 116 based on one or more rank offsets as discussed herein. The UE 104 may include rank offset circuitry 124 to generate the one or more rank offsets. The rank offset may be based on a performance metric (such as spectral efficiency and/or another suitable metric) for downlink transmissions to the UE 104 using SU-MIMO compared with MU-MIMO. In an example, the UE 104 may include a transmission mode detector 128 to detect a transmission mode (e.g., SU-MIMO or MU-MIMO) of downlink transmissions. The transmission mode detector 128 may enable the UE 104 to determine the performance metric for the respective transmission modes (e.g., based on measurements on transmissions that are determined to be transmitted using the respective transmission mode).

The network may be configured to schedule the UE 104 for SU-MIMO with a higher reported RI and MU-MIMO with a lower reported RI. Accordingly, in scenarios in which the determined rank metric is between reportable values of the RI, the rank offset may bias the UE 104 toward reporting the rank that leads to scheduling the transmission mode (e.g., SU-MIMO or MU-MIMO) with the greater performance metric (e.g., spectral efficiency). For example, the rank offsets may bias the RI toward a higher rank when the performance metric for SU-MIMO is better than the performance metric for MU-MIMO and/or may bias the RI toward a lower rank when the performance metric for MU-MIMO is better than the performance metric for SU-MIMO. The rank offsets may enable the CSI feedback 116 to provide a better indication to the network of demodulation performance when the network switches between different transmission modes (e.g., SU-MIMO and MU-MIMO).

In an example, the CSI-RS 112 is sent on a downlink channel. The base station 108 can receive and use the CSI report 120 to optimize and enhance the efficiency of the downlink channel (and possibly of an uplink channel if channel reciprocity is assumed). The CSI feedback 116 in the CSI report 120 provides information about the downlink channel by including parameters such as the RI, a channel quality indicator (CQI—indicating the quality of the channel), a precoding matrix indicator (PMI—providing information about the preferred precoding matrix, which is used for beamforming and spatial multiplexing, allowing the base station 108 to adjust the antenna array to maximize signal strength and quality), and/or CSI-RS measurements (allowing the base station 108 to more accurately evaluate the channel conditions). This information can enable the base station 108 to, among other things, determine a number of layers to use for a transmission to the UE 104, determine a transmission mode to use with the UE 104 (e.g., SU-MIMO, MU-MIMO, or another transmission mode), adjust the modulation and coding schemes dynamically, maximize data throughput, maintain reliable communication, and/or control its beamforming.

The base station 108 may transmit information (for example, data and control signaling) in the downlink direction by mapping logical channels on the transport channels, then transport channels onto physical channels. The logical channels may transfer data between a radio link control (RLC) and media access control (MAC) layers; the transport channels may transfer data between the MAC and PHY layers; and the physical channels may transfer information across the air interface. The physical channels may include a physical broadcast channel (PBCH); a physical downlink control channel (PDCCH); and a physical downlink shared channel (PDSCH).

The PBCH may be used to broadcast system information that the UE 104 may use for initial access to a serving cell. The PBCH may be transmitted along with physical synchronization signals (PSS) and secondary synchronization signals (SSS) in a synchronization signal (SS)/PBCH block. The SS/PBCH blocks (SSBs) may be used by the UE 104 during a cell search procedure and for beam selection.

The PDSCH may be used to transfer end-user application data, signaling radio bearer (SRB) messages, system information messages (other than, for example, MIB), and paging messages.

The PDCCH may transfer downlink control information (DCI) that is used by a scheduler of the base station 108 to allocate both uplink and downlink resources. The DCI may also be used to provide uplink power control commands, configure a slot format, or indicate that preemption has occurred.

The base station 108 may also transmit various reference signals to the UE 104. The reference signals may include demodulation reference signals (DMRSs) for the PBCH, PDCCH, and PDSCH. The UE 104 may compare a received version of the DMRS with a known DMRS sequence that was transmitted to estimate an impact of the propagation channel. The UE 104 may then apply an inverse of the propagation channel during a demodulation process of a corresponding physical channel transmission.

The reference signals may also include a CSI-RS (e.g., the CSI-RS 112 discussed above). The CSI-RS may be a multi-purpose downlink transmission signal that may be used for CSI reporting, beam management, connected mode mobility, radio link failure detection, beam failure detection and recovery, and fine-tuning of time and frequency synchronization.

The reference signals and information from the physical channels may be mapped to resources of a resource grid. There is one resource grid for a given antenna port, subcarrier spacing configuration, and transmission direction (for example, downlink or uplink). The basic unit of an NR downlink resource grid may be a resource element, which may be defined by one subcarrier in the frequency domain, and one orthogonal frequency division multiplexing (OFDM) symbol in the time domain. Twelve consecutive subcarriers in the frequency domain may compose a physical resource block (PRB). A resource element group (REG) may include one PRB in the frequency domain, and one OFDM symbol in the time domain, for example, twelve resource elements. A control channel element (CCE) may represent a group of resources used to transmit PDCCH. One CCE may be mapped to a number of REGs; for example, six REGs.

The UE 104 may transmit data and control information to the base station 108 using physical uplink channels. Different types of physical uplink channels are possible, including a physical uplink control channel (PUCCH) and a physical uplink shared channel (PUSCH). Whereas the PUCCH carries control information from the UE 104 to the base station 108, such as uplink control information (UCI), the PUSCH carries data traffic (e.g., end-user application data) and can carry UCI.

In an example, communications with the base station 108 can use channels in the frequency range 1 (FR1) band and/or frequency range 2 (FR2) band, although other frequency ranges are possible. The FR1 band includes a licensed band and an unlicensed band. The NR unlicensed band (NR-U) includes a frequency spectrum that is shared with other types of radio access technologies (RATs) (e.g., LTE-LAA, WiFi, etc.). A listen-before-talk (LBT) procedure can be used to avoid or minimize collision between the different RATs in the NR-U, whereby a device applies a clear channel assessment (CCA) check before using the channel.

The UE 104 can be located within a network coverage. In particular, the base station 108 may provide the network coverage with signaling (e.g., which may be carried by one or more beams). The network coverage may represent a cell or a portion of the cell that the base station 108 provides. The network coverage may provide network connections to multiple UEs, similar to the UE 104. These UEs may communicate with the base station 108 on both the uplink and the downlink based on channels available to them when the UEs are in the network coverage.

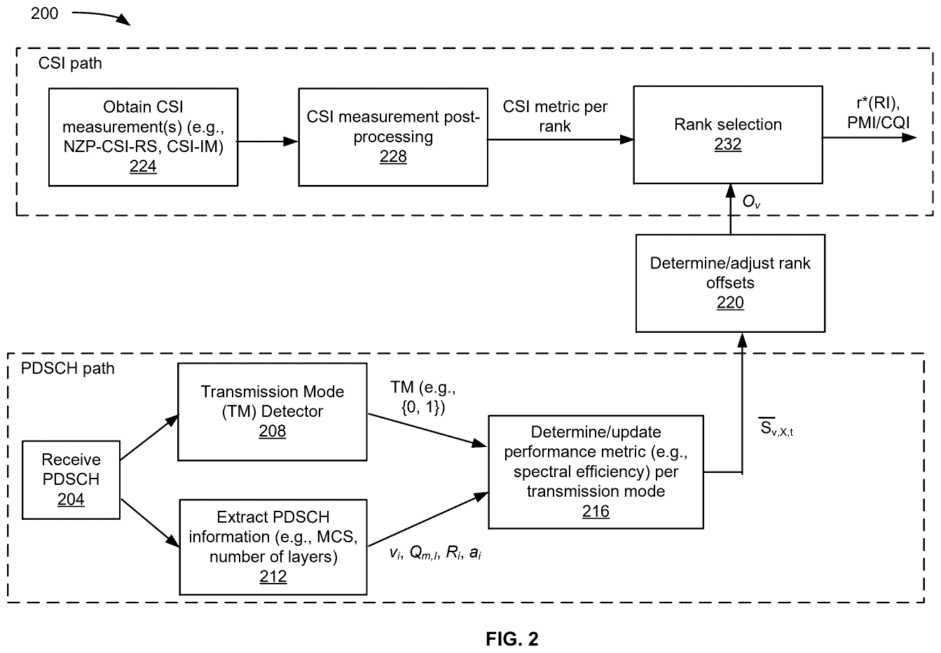

FIG. 2 illustrates an example procedure 200 for rank selection for CSI feedback, in accordance with some embodiments. As shown, aspects of the procedure 200 may be performed in a PDSCH path and a CSI path. The procedure 200 may be performed by a UE, such as UE 104, or components thereof.

At 204 of the procedure 200, the UE may receive a PDSCH. The PDSCH may be associated with a downlink grant and may be received on a set of time-frequency resources. Although the procedure 200 is described with reference to a PDSCH, the procedure 200 may additionally or alternatively be used with other downlink signals. In an example, the UE may receive a PDSCH configuration from the network to indicate one or more parameters for the PDSCH. The network may send a PDSCH grant to the UE to schedule the PDSCH (e.g., when there is downlink traffic intended for the UE). In an example, the PDSCH grant is included in DCI.

At 208 of the procedure 200, a transmission mode detector of the UE detects the transmission mode used for the PDSCH. In an example, the transmission mode detector may detect whether the PDSCH was transmitted using SU-MIMO or MU-MIMO. For example, the transmission mode detector may generate an output that has a value of 0 to indicate SU-MIMO operation or a value of 1 to indicate MU-MIMO operation. In some instances, the transmission mode detector may have a detection probability, P_{d}. For example, the output of the transmission mode detector may be between 0 and 1, with a value closer to 0 indicating a higher probability of SU-MIMO operation and a value closer to 1 indicating a higher probability of MU-MIMO operation.

The transmission mode detector may use any suitable detection scheme. For example, the transmission mode detector may obtain measurements on DMRS resources associated with MU-MIMO operation (e.g., that may be used by another UE to receive its transmission), and the output may be based on whether significant energy (e.g., greater than a threshold) is detected on the DMRS resources. The DMRS resources may be different than the DMRS resources used for PDSCH reception by the UE that is performing procedure 200.

At 212 of the procedure 200, the UE may extract additional information associated with the PDSCH. For example, the additional information may include a number of layers, a modulation and coding scheme (MCS, e.g., based on an MCS index indicated by the PDSCH grant), a number of bits for a modulation scheme associated with the MCS (e.g., 2 bits for quadrature phase shift keying (QPSK), 4 bits for 16-quadrature amplitude modulation (QAM), or 8 bits for 256QAM), a coding rate associated with the MCS, and/or ACK/NACK information associated with the PDSCH (e.g., indicative of the block error rate (BLER)). The additional information may be extracted from the PDSCH grant (e.g., DCI) and/or from the PDSCH itself.

At 216 of the procedure 200, the UE may determine a performance metric associated with the respective transmission modes (e.g., SU-MIMO and MU-MIMO). In an example, separate performance metrics may be generated per-number-of-layers and per-transmission mode (e.g., a separate metric for individual pairs of transmission mode and number of layers). The performance metric may be determined based on the output of the transmission mode detector and the additional information extracted at 212. The performance metric may be determined over a rolling observation window, e.g., the metric may be successively updated based on new downlink transmissions.

In some embodiments, the performance metric may include spectral efficiency and/or another metric that is correlated with spectral efficiency (e.g., scheduled PDSCH throughput, average BLER, etc.). For example, the spectral efficiency of the DL transmission (e.g., PDSCH) at time t for a given number of layers, averaged over an observation window or duration T, is given by:

$${\overline{s}}_{v , t} = \frac{v}{T} {\sum }_{i = T - t + 1}^{T} {Q}_{m , i} \cdot {R}_{i} \cdot {a}_{i}$$

where:
v is the number of layers scheduled;
Q_{m,i} is the number of bits for a given modulation scheme (e.g., 2 for QPSK, 4 for 16QAM, 8 for 256QAM);
Rᵢ is the coding rate;
aᵢ ∈{0,1} is ACK/NACK information.

The UE may identify the values of Q_{m,i} and Rᵢ based on the MCS index used for the i-th PDSCH grant.

At 220 of the procedure 200, the UE may determine one or more rank offsets (Oᵥ) based on the spectral efficiency of the respective transmission modes and number of layers. In some embodiments, the rank offset may be generated iteratively as new spectral efficiency information is available (e.g., by updating the prior rank offset based on the new spectral efficiency information).

In an example, the rank offset for a given transmission mode and number of layers may be given by:

$${O}_{v , t + 1} = {αO}_{v , t} + ( 1 - α ) g ( {\overline{s}}_{v , MU , t} , {\overline{s}}_{v , SU , t} )$$

where:
α is a tunable step-size (e.g., to control convergence); and
g(·) is a mapping function that takes s̅_{v,MU,t} (the spectral efficiency of MU-MIMO) and s̅_{v,SU,t} (the spectral efficiency of SU-MIMO) as inputs and outputs a positive or negative offset to be applied to the prior rank offset value (O_{v,t}).

Two examples of the mapping function g(·) are described further below. These mapping functions are merely examples, and it will be apparent that other mapping functions may be used in accordance with various embodiments herein.

In a first example, the current rank may be promoted if the two transmission modes have similar spectral efficiency. However, if the spectral efficiency of the current transmission mode is worse than the spectral efficiency of the other transmission mode, then the rank offset of the next highest rank (e.g., current rank+1) may be increased if the current transmission mode is MU-MIMO or the rank offset of the next lowest rank (e.g., current rank −1) may be increased if the current transmission mode is SU-MIMO.

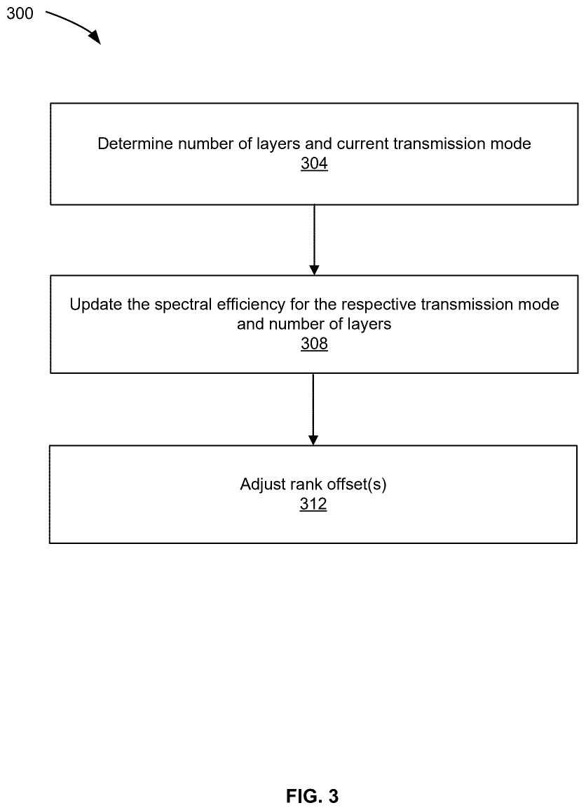

In an example, for a new PDSCH grant at time t, the UE may perform a procedure 300, as illustrated in FIG. 3. At 304, the UE may determine the number of layers, vₜ, and the current transmission mode (e.g., using the transmission mode detector).

At 308 of the procedure 300, the UE may update the spectral efficiency for the respective transmission mode and number of layers. For example, the spectral efficiency may be s̅_{v,X,t}, where vis the number of layers and X is SU for SU-MIMO or MU for MU-MIMO. The spectral efficiency may be updated based on information associated with the PDSCH grant, such as the number of layers, the modulation scheme, the coding rate, and/or ACK/NACK information (e.g., the BLER).

At 312 of the procedure 300, the UE may adjust the rank offsets. For example, if the PDSCH grant is MU-MIMO, the UE may keep the current rank if the spectral efficiency of MU-MIMO is similar to the spectral efficiency of SU-MIMO (e.g., within a threshold β that can be made a function of the transmission mode detection probability). Otherwise, the UE may promote the next higher rank in the set of candidate ranks (e.g., to reduce MU-MIMO opportunity/likelihood). For example:
If β·s̅_{v,MU,t}>s̅_{v,SU,t}, then increase the rank offset of the current rank:

$${O}_{v , t + 1} = {αO}_{v , t} + ( 1 - α ) ( βγ \cdot {\overline{s}}_{v , MU , t} - {\overline{s}}_{v , SU , t} )$$

Else if β·s̅_{v,MU,t}<s̅_{v,SU,t} AND s̅_{v+1,SU,t}>s̅_{v,SU,t}, then increase the rank offset of the next higher rank:

$${O}_{v + 1 , t + 1} = {αO}_{v + 1 , t} + ( 1 - α ) ( {\overline{s}}_{v + 1 , SU , t} - {\overline{s}}_{v , SU , t} )$$

Else no update to rank offsets.

If the PDSCH grant is SU-MIMO, the UE may keep the current rank if the spectral efficiency of SU-MIMO is similar to the spectral efficiency of MU-MIMO (e.g., within a threshold). Otherwise, the UE may promote the next lower rank in the set of candidate ranks (e.g., to increase MU-MIMO opportunity/likelihood). For example:
If s̅_{v,SU,t}>β·s̅_{v,MU,t}, then increase the rank offset of the current rank:

$${O}_{v , t + 1} = {αO}_{v , t} + ( 1 - α ) ( {\overline{s}}_{v , SU , t} - β \cdot {\overline{s}}_{v , MU , t} )$$

Else if s̅_{v,SU,t}<β·s̅_{v,MU,t} AND s̅_{v+1,MU,t}>s̅_{v,MU,t}, then increase the rank offset of the next lower rank:

$${O}_{v - 1 , t + 1} = {αO}_{v - 1 , t} + ( 1 - α ) ( {\overline{s}}_{v - 1 , MU , t} - {\overline{s}}_{v , MU , t} )$$

Else no update to rank offsets.

In a second example of the mapping function, when the scheduled number of layers changes, the UE checks if there is a transmission mode change (e.g., from SU-MIMO to MU-MIMO or from MU-MIMO to SU-MIMO) and whether there has been an impact on the spectral efficiency. The rank offset may be determined to bias toward the previous rank if the spectral efficiency with the new rank and/or transmission mode has degraded (e.g., more than a threshold in some embodiments).

In an example, for a new PDSCH grant at time t, the UE may perform segments and/or the entirety of the following procedure:
Determine the number of layers, vₜ.
Adjust the respective spectral efficiency.
If vₜ=vₜ₋₁, do not update the rank offsets.
Else if vₜ≠vₜ₋₁ but the same transmission mode is used (no change in transmission mode), do not update the rank offsets.
Else if vₜ≠vₜ₋₁ and there is a change in transmission mode:
   If the transmission mode change is from SU-MIMO to MU-MIMO, reset s̅ᵥ_{ₜ}_{, MU,t} and monitor s̅ᵥ_{_{t−1}}_{,MU,t} for a window duration W (which may correspond to a number of slots and may be a tunable parameter in some embodiments). After the window duration W:
      If s̅ᵥ_{ₜ}_{,MU,t+W}>s̅ᵥ_{_{t−1}}_{,SU,t-1}, do not update the rank offsets.
      Else: sv̅ᵥ_{ₜ}_{MU,t+W}<s̅ᵥ_{_{t−1}}_{,SU,t-1}, reduce the rank offset of the new rank:

$${O}_{{v}_{t} , t + W + 1} = {αO}_{{v}_{t} , t + W} + ( 1 - α ) ( {\overline{s}}_{{v}_{t} , MU , t} - {\overline{s}}_{{v}_{t - 1} , SU , t - 1} )$$

If the transmission mode change is from MU-MIMO to SU-MIMO, reset s̅ᵥ_{ₜ}_{,SU,t} and monitor s̅ᵥ_{_{t−1}}_{,SU,t} for a window duration W (which may correspond to a number of slots and may be a tunable parameter in some embodiments). After the window duration W:
   If s̅ᵥ_{ₜ}_{SU,t+W}>s̅ᵥ_{_{t−1}}_{,MU,t-1}, do not update the rank offsets.
   Else: s̅ᵥ_{ₜ}_{,SU,t+W}<s̅ᵥ_{_{t−1}}_{,MU,t-1}, reduce the rank offset of the new rank:

$${O}_{{v}_{t} , t + W + 1} = {αO}_{{v}_{t} , t + W} + ( 1 - α ) ( {\overline{s}}_{{v}_{t} , SU , t} - {\overline{s}}_{{v}_{t - 1} , MU , t - 1} )$$

Other schemes may be used to determine/update the rank offsets in accordance with various embodiments. In an example, the rank offset may be adjusted by a fixed, pre-determined value instead of based on the difference between the spectral efficiencies of SU-MIMO and MU-MIMO. For example, the rank offsets may be adjusted according to:

$${O}_{v , t + 1} = {αO}_{v , t} + ( 1 - α ) {γ}_{v}$$

where γᵥ is a fixed, pre-determined value.

Referring again to FIG. 2, in the CSI path of the procedure 200, at 224, the UE may obtain one or more CSI measurements. In an example, the one or more CSI measurements may include a channel measurement (e.g., a non-zero power (NZP)-CSI-RS measurement) and/or an interference measurement (e.g., a CSI-interference measurement (IM)). The one or more CSI measurements may include, for example, I/Q samples.

In an example, the UE receives a CSI report configuration and/or a CSI resource configuration from the network. The CSI report configuration may indicate one or more parameters for the CSI report, while the CSI resource configuration may indicate the time-frequency resources of the CSI-RS(s). For a given report configuration, the network may transmit one or more CSI-RSs, such as an NZP-CSI-RS (on which the UE performs the NZP-CSI-RS measurement) and/or a CSI-IM (on which the UE performs the CSI-IM).

At 228 of the procedure 200, the UE may perform CSI measurement post-processing to generate a CSI metric. Individual CSI metrics may be generated for respective rank hypotheses (e.g., candidate ranks that are under consideration for the RI). In an example, [symbol] may correspond to the set of applicable rank hypotheses for a given CSI report. The set may be based on the UE's maximum rank capability (e.g., for a given frequency band), a number of transmit ports used for CSI resources associated with the CSI report, and/or a rank restriction of the CSI report (e.g., indicated by the network in RRC parameter ri-Restriction). To illustrate an example, in a 4 Rx band with 8-port CSI-RS and re-Restriction=0xF, [symbol] ={1, 2, 3, 4}. In some embodiments, the UE may perform rank search and selection (e.g., including the CSI measurement post-processing at 228 and/or the rank selection at 232 of procedure 200) using a subset of all possible rank hypotheses (e.g., to reduce rank search complexity). The subset (e.g., [symbol] ⊆ [symbol] ) may include the rank hypotheses that are relatively more likely to be selected, e.g., based on channel conditions and/or other information.

In some embodiments, the CSI metric may be the same or similar to the performance metric used to determine the rank offsets (e.g., spectral efficiency), except generated based on the CSI-RS instead of PDSCH. In other embodiments, the CSI metric may be a different metric from the performance metric.

In an example, the CSI metric may be based on a precoder that will be reported to the network in the CSI report (e.g., via PMI). The UE may perform a precoder selection process to select the precoder. In an example, the precoder may be selected based on the associated performance metric. For example, the CSI metric may be computed for respective precoders in the rank-specific codebook and the precoder with the greatest CSI metric may be selected.

At 232 of the procedure 200, the UE performs rank selection. The rank selection may be performed based on the CSI metrics and the rank offsets. For example, the UE may apply (e.g., add) a corresponding rank offset to the respective CSI metrics to generate respective compensated CSI metrics. The UE may select a rank to report (e.g., the RI) based on the compensated CSI metrics. For example, the UE may select the RI with the highest compensated CSI metric.

Accordingly, the rank offsets may only affect the reported rank in boundary situations in which the uncompensated CSI metrics are close between two different ranks and there is a significant difference in performance metrics between SU and MU operation. When the CSI metrics are significantly different, the rank offset may not be significant enough to change the reported rank. Additionally, when SU and MU operation have similar performance metrics, the rank offsets may have lower values (e.g., at or near zero). However, in situations in which the performance between SU and MU operation is significantly different, the rank offsets may be used to bias the reported rank toward the rank that promotes the transmission mode with better performance (e.g., higher rank if SU has better performance or lower rank if MU has better performance).

In an example, the UE may further determine a CQI to report based on the CSI metric. For example, the UE may use a CSI metric-to-CQI mapping table to select the CQI for the selected rank (e.g., the RI).

In an example, rank hysteresis and/or time-domain filtering may be used to reduce the frequency of toggling between reported ranks. In another example, different rank penalties may be used to restrict specific RI reporting under certain conditions. For example, the rank penalties may cause the UE to report RI=4 only at high SNR even if it can provide slightly higher CSI metric over RI=3 at lower SNR.

At 236 of the procedure 200, the UE may generate the CSI report for transmission including the RI. The CSI report may further include the PMI and/or CQI. In an example, the CSI report may be transmitted in a PUCCH or a PUSCH.

Various enhancements to the rank offset determination may be used in accordance with embodiments herein. In an example, if a particular rank and transmission mode pair is not scheduled for a time period, the rank offset for that rank and transmission mode pair may be reset (e.g., to zero) or adaptively move toward zero. A similar scheme may be used if a particular transmission mode has not been scheduled for a time period regardless of rank. For example, if SU-MIMO transmission has not been detected for the time period (e.g., MU-MIMO is consistently detected), then the UE may reset the rank offsets to zero. In some embodiments, the time period may be adaptively tuned (e.g., based on performance or other factors).

In another example, the rank offsets may be adjusted when the network is in-sync with respect to CSI reports and not when the network is out-of-sync with respect to CSI Reports. For example, the network may instead use SRS to decide the rank for downlink transmissions and may not follow the CSI feedback.

In another example, the rank offsets may be adjusted when the transmission mode detection probability (Pa) exceeds a threshold and may not be adjusted when the transmission mode detection probability does not exceed the threshold. The detection probability may change over time, e.g., based on the scenario and/or channel conditions. In some embodiments, the adjustment to the rank offset may be weighted based on the transmission mode detection probability (e.g., with a greater adjustment for a higher probability). In other embodiments, the same adjustment may be made across probability values (e.g., so long as the probability exceeds the threshold).

In another example, different weights and/or boosting factors may be used for rank offsets used for a SU-to-MU transition compared with a MU-to-SU transition. For example, the rank offset for one type of transition may be adjusted more aggressively than for the other type of transition given similar differences in spectral efficiency. In another example, the rank offsets may only be used for one type of transition (e.g., SU-to-MU or MU-to-SU) and not the other. For example, the rank offsets may be used/updated to bias toward MU-to-SU transition when the spectral efficiency of MU is worse than SU, but rank offsets may not be used/updated for SU-to-MU transition.

In another example, the rank offsets and/or rank selection may be based on a codebook configuration (e.g., Type-I or Type-II) of the CSI report. For example, if Type-I codebook is configured, the rank offsets may be used for MU-to-SU transitions but not SU-to-MU transitions. If Type-II codebook is configured, the rank offsets may be used for SU-to-MU transitions but not for MU-to-SU transitions.

In another example, the rank offsets may be used for certain numbers of CSI-RS ports used to transmit the CSI-RS and/or when the number of CSI-RS ports is at least a threshold number of CSI-RS ports (e.g., at least 8 CSI-RS ports).

In another example, the rank offsets may be determined/maintained per-carrier and/or per-CSI report configuration. For example, with per-carrier rank offsets, the UE may apply the same rank offsets across multiple CSI report configurations. Since the rank offsets may be adjusted based on the PDSCH traffic received on the carrier, the rank offsets may be relevant across all CSI report configurations on the carrier.

With per-CSI report configuration, the UE may use different rank offsets across different CSI report configurations on the same carrier. In this case, the UE may determine with CSI report configuration is being used by the network for a given PDSCH to determine the CSI report configuration for which the rank offsets will be adjusted based on the PDSCH. In an example, the CSI report configuration may be inferred based on the PDSCH grant (e.g., DCI).

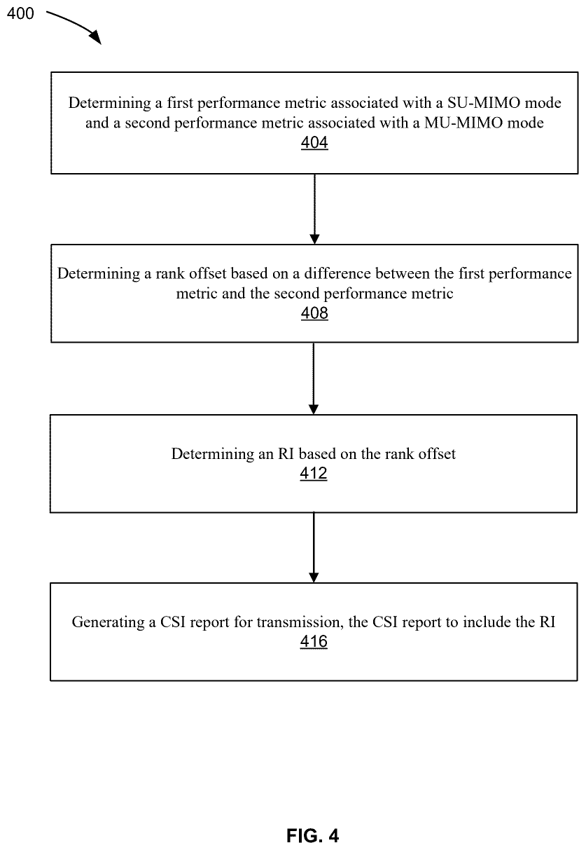

FIG. 4 illustrates an example of an operational flow/algorithmic structure 400 for rank selection based on a rank offset, in accordance with some embodiments. The operational flow/algorithmic structure 400 can be implemented by a UE (e.g., performed by components thereof including, for example, an apparatus of the UE, where the apparatus includes processing circuitry; a modem is an example of such an apparatus). The UE can be any of the UEs described herein. In some embodiments, the operational flow/algorithmic structure 400 may be implemented by executing instructions stored in a tangible, non-transitory, computer-readable storage medium, such as a memory of the UE. While the operational flow/algorithmic structure 400 is described using steps in a specific sequence, it should be understood that the present disclosure contemplates that the described steps may be performed in different sequences than the sequence illustrated, and certain described steps may be omitted or not performed altogether.

In an example, the operational flow/algorithmic structure 400 includes, at 404, determining a first performance metric associated with a SU-MIMO mode and a second performance metric associated with a MU-MIMO mode. The performance metric may include, for example, spectral efficiency, and/or another metric such as PDSCH throughput and/or BLER. In an example, the performance metric may be determined based on information extracted from the PDSCH grant and/or the PDSCH, such as the number of layers scheduled, the MCS (e.g., the number of bits for the associated modulation scheme and/or the coding rate), and/or ACK/NACK information (e.g., indicative of BLER).

The operational flow/algorithmic structure 400 further includes, at 408, determining a rank offset based on a difference between the first performance metric and the second performance metric. For example, the rank offset may be determined in accordance with any of the examples described above with respect to FIG. 2. In some embodiments, the rank offset may be associated with a candidate rank (e.g., number of layers) and a transmission mode (e.g., SU-MIMO or MU-MIMO). The UE may determine a plurality of rank offsets, with individual rank offsets associated with a respective pair of candidate rank and transmission mode.

In an example, determining the rank offset includes adjusting the prior value of the rank offset by an adjustment amount based on a PDSCH grant, wherein the PDSCH grant is associated with a first candidate rank and the rank offset is associated with a second candidate rank that is a next higher rank or a next lower rank than the first candidate rank. For example, the adjustment amount may be applied to increase the rank offset for the second candidate rank that is the next higher rank than the first candidate rank based on the first performance metric at the first candidate rank being better than the second performance metric at the first candidate rank. In another example, the adjustment amount may be applied to increase the rank offset for the second candidate rank that is the next lower rank than the first candidate rank based on the second performance metric at the first candidate rank being better than the first performance metric at the first candidate rank.

The operational flow/algorithmic structure 400 further includes, at 412, determining an RI based on the rank offset. For example, the UE may generate CSI metrics for respective candidate ranks based on CSI measurements. The UE may apply the respective rank offsets to the CSI metrics to generate compensated CSI metrics. The UE may determine the RI based on the compensated CSI metric (e.g., by selecting the candidate rank with the highest compensated CSI metric). The UE may apply the rank offsets that correspond to a current transmission mode (e.g., SU-MIMO or MU-MIMO).

The operational flow/algorithmic structure 400 further includes, at 416, generating a CSI report for transmission, the CSI report to include the RI. The CSI report may be transmitted to the network, e.g., in a PUCCH or PUSCH.

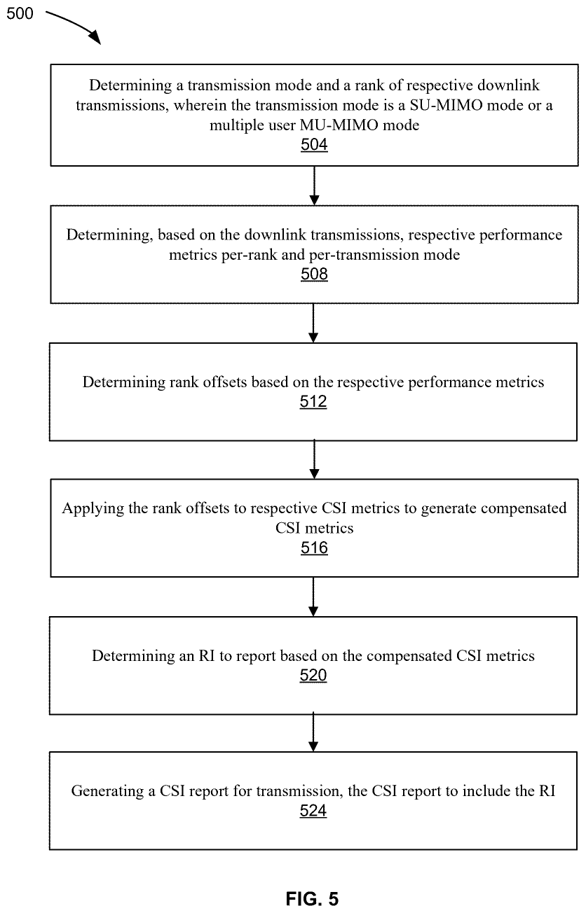

FIG. 5 illustrates another example of an operational flow/algorithmic structure for rank selection with a rank offset in accordance with some embodiments. The operational flow/algorithmic structure 500 can be implemented by a UE (e.g., performed by components thereof including, for example, an apparatus of the UE, where the apparatus includes processing circuitry; a modem is an example of such an apparatus). The UE can be any of the UEs described herein. In some embodiments, the operational flow/algorithmic structure 500 may be implemented by executing instructions stored in a tangible, non-transitory, computer-readable storage medium, such as a memory of the UE. While the operational flow/algorithmic structure 500 is described using steps in a specific sequence, it should be understood that the present disclosure contemplates that the described steps may be performed in different sequences than the sequence illustrated, and certain described steps may be omitted or not performed altogether. Further, one or more operations of the operational flow/algorithmic structure 500 can include one or more operations of the operational flow/algorithmic structure 400.

In an example, the operational flow/algorithmic structure 500 includes, at 504, determining a transmission mode and a rank of respective downlink transmissions, wherein the transmission mode is a SU-MIMO mode or a multiple user MU-MIMO mode. For example, the UE may detect a probability that the transmission mode is the SU-MIMO mode or the MU-MIMO mode (e.g., based on detection of energy on other DMRS resources). In an example, the UE may determine the rank based on the DCI that provides the PDSCH grant.

The operational flow/algorithmic structure 500 further includes, at 508, determining, based on the downlink transmissions, respective performance metrics per-rank and per-transmission mode. The performance metrics may include, for example, spectral efficiencies and/or another metric such as PDSCH throughput and/or BLER. In an example, the performance metric may be determined based on information extracted from the PDSCH grant and/or the PDSCH, such as the number of layers scheduled, the MCS (e.g., the number of bits for the associated modulation scheme and/or the coding rate), and/or ACK/NACK information (e.g., indicative of BLER).

The operational flow/algorithmic structure 500 further includes, at 512, determining rank offsets based on the respective performance metrics. For example, the rank offsets may be determined in accordance with any of the examples described above with respect to FIG. 2. In some embodiments, the rank offsets may be associated with a respective pair of candidate rank (e.g., number of layers) and transmission mode (e.g., SU-MIMO or MU-MIMO).

The operational flow/algorithmic structure 500 further includes, at 516, applying the rank offsets to respective CSI metrics to generate compensated CSI metrics. For example, the rank offsets may be added to the respective CSI metrics.

The operational flow/algorithmic structure 500 further includes, at 520, determining an RI to report based on the compensated CSI metrics. For example, the UE may select the RI that corresponds to the highest compensated CSI metric.

The operational flow/algorithmic structure 500 further includes, at 524, generating a CSI report for transmission, the CSI report to include the RI. The CSI report may be transmitted to the network, e.g., in a PUCCH or PUSCH.

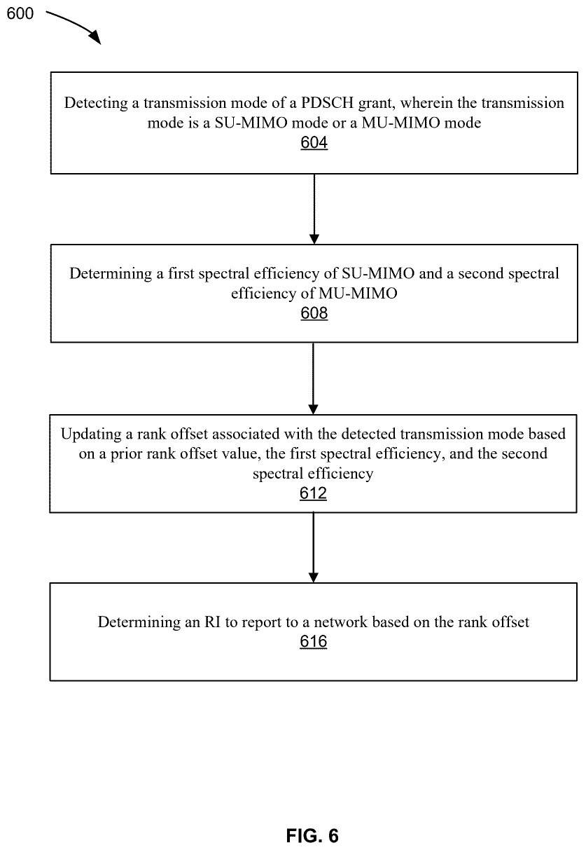

FIG. 6 illustrates another example of an operational flow/algorithmic structure 600 for rank selection based on a rank offset, in accordance with some embodiments. The operational flow/algorithmic structure 600 can be implemented by a UE (e.g., performed by components thereof including, for example, an apparatus of the UE, where the apparatus includes processing circuitry; a modem is an example of such an apparatus). The UE can be any of the UEs described herein. In some embodiments, the operational flow/algorithmic structure 600 may be implemented by executing instructions stored in a tangible, non-transitory, computer-readable storage medium, such as a memory of the UE. While the operational flow/algorithmic structure 600 is described using steps in a specific sequence, it should be understood that the present disclosure contemplates that the described steps may be performed in different sequences than the sequence illustrated, and certain described steps may be omitted or not performed altogether. Further, one or more operations of the operational flow/algorithmic structure 600 can include one or more operations of the operational flow/algorithmic structure 400 and/or 500.

In an example, the operational flow/algorithmic structure 600 includes, at 604, detecting a transmission mode of a PDSCH grant, wherein the transmission mode is a SU-MIMO mode or a MU-MIMO mode. For example, the UE may detect a probability that the transmission mode is the SU-MIMO mode or the MU-MIMO mode (e.g., based on detection of energy on other DMRS resources).

The operational flow/algorithmic structure 600 further includes, at 608, determining a first spectral efficiency of SU-MIMO and a second spectral efficiency of MU-MIMO. For example, the first and/or second spectral efficiencies may be determined based on information extracted from the PDSCH grant and/or the PDSCH, such as the number of layers scheduled, the MCS (e.g., the number of bits for the associated modulation scheme and/or the coding rate), and/or ACK/NACK information (e.g., indicative of BLER).

The operational flow/algorithmic structure 600 further includes, at 612, updating a rank offset associated with the detected transmission mode based on a prior value of the rank offset, the first spectral efficiency, and the second spectral efficiency. For example, the rank offset may be determined in accordance with any of the examples described above with respect to FIG. 2. In some embodiments, the rank offset may be associated with a respective candidate rank (e.g., number of layers) in addition to the transmission mode.

The operational flow/algorithmic structure 600 further includes, at 616, determining an RI to report to a network based on the rank offset. For example, the UE may generate CSI metrics for respective candidate ranks based on CSI measurements. The UE may apply the respective rank offsets to the CSI metrics to generate compensated CSI metrics. The UE may determine the RI based on the compensated CSI metric (e.g., by selecting the candidate rank with the highest compensated CSI metric). The UE may apply the rank offsets that correspond to a current transmission mode (e.g., SU-MIMO or MU-MIMO).

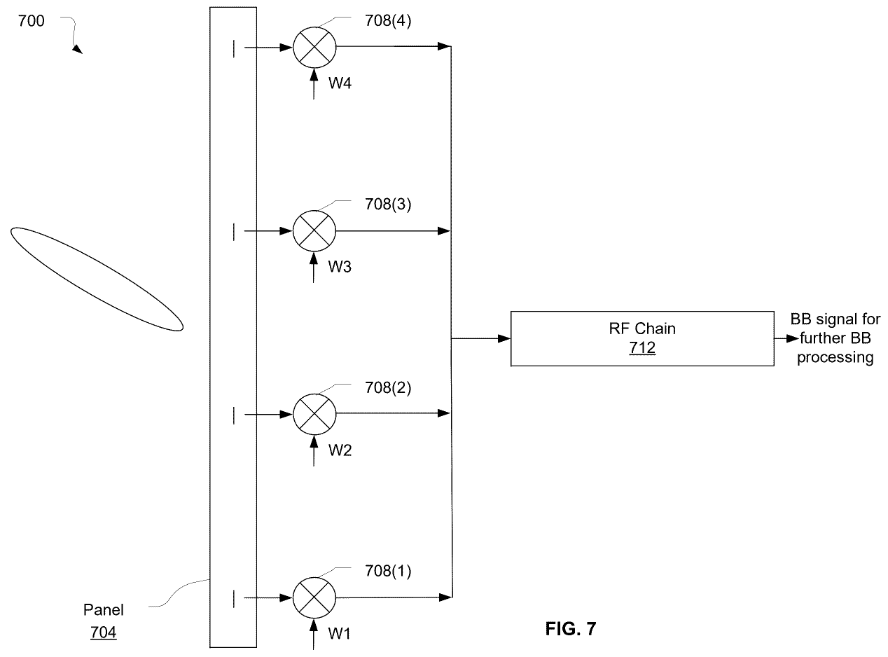

FIG. 7 illustrates receive components 700 of a UE, such as any of the UE's described herein above, in accordance with some embodiments. The receive components 700 may include an antenna panel 704 that includes a number of antenna elements. The panel 704 is shown with four antenna elements, but other embodiments may include other numbers.

The antenna panel 704 may be coupled to analog beamforming (BF) components that include a number of phase shifters 708(1)-708(4). The phase shifters 708(1)-708(4) may be coupled with a radio-frequency (RF) chain 712. The RF chain 712 may amplify a receive analog RF signal, downconvert the RF signal to baseband, and convert the analog baseband signal to a digital baseband signal that may be provided to a baseband processor for further processing. In an example, receive components 700 can include multiple antenna panels 704 and/or multiple RF chains 712. An MR can include an antenna panel 704 and an RF chain 712. An LP-WUR can include the same antenna panel 704 or a different antenna panel and a different RF chain 712.

In various embodiments, control circuitry, which may reside in a baseband processor, may provide BF weights (for example W1-W4), which may represent phase shift values, to the phase shifters 708(1)-708(4) to provide a receive beam at the antenna panel 704. These BF weights may be determined based on the channel-based beamforming.

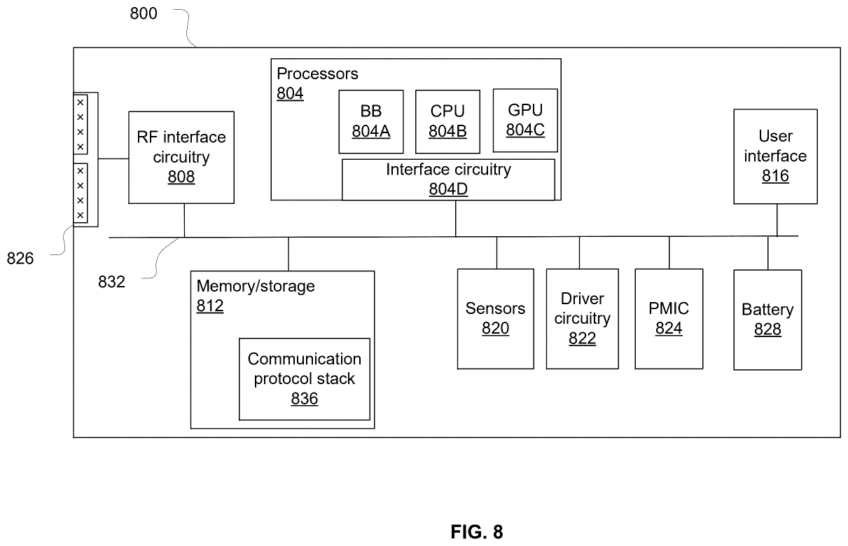

FIG. 8 illustrates a UE 800, in accordance with some embodiments. The UE 800 may be similar to and substantially interchangeable with any of the UEs described herein above. Particularly, the UE 800 can support rank selection for CSI using rank offsets as described herein.

Similar to that described above with respect to UE 104, the UE 800 may be any mobile or non-mobile computing device, such as mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, actuators, etc.), video surveillance/monitoring devices (for example, cameras, video cameras, etc.), wearable devices, or relaxed-IoT devices. In some embodiments, the UE may be a reduced capacity UE or NR-Light UE.

The UE 800 may include processors 804, RF interface circuitry 808, memory/storage 812, user interface 816, sensors 820, driver circuitry 822, power management integrated circuit (PMIC) 824, and battery 828. The components of the UE 800 may be implemented as integrated circuits (ICs), portions thereof, discrete electronic devices, or other modules, logic, hardware, software, firmware, or a combination thereof. In an example, one or more of processors 804 may include RF interface circuitry 808. The block diagram of FIG. 8 is intended to show a high-level view of some of the components of the UE 800. However, some of the components shown may be omitted, additional components may be present, and different arrangements of the components shown may occur in other implementations.

The components of the UE 800 may be coupled with various other components over one or more interconnects 832, which may represent any type of interface, input/output, bus (local, system, or expansion), transmission line, trace, optical connection, etc. that allows various circuit components (on common or different chips or chipsets) to interact with one another.

The processors 804 may include processor circuitry, such as baseband processor circuitry (BB) 804A, central processor unit circuitry (CPU) 804B, and graphics processor unit circuitry (GPU) 804C. The processors 804 may include any type of circuitry or processor circuitry that executes or otherwise operates computer-executable instructions, such as program code, software modules, or functional processes from memory/storage 812 to cause the UE 800 to perform operations as described herein. The processors 804 may also include interface circuitry 804D to enable communication by, for example, communicatively coupling the processor circuitry with one or more other components of the UE 800.

In some embodiments, the baseband processor circuitry 804A may access a communication protocol stack 836 in the memory/storage 812 to communicate over a 3GPP compatible network. In general, the baseband processor circuitry 804A may access the communication protocol stack to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a non-access stratum “NAS” layer. In some embodiments, the PHY layer operations may additionally/alternatively be performed by the components of the RF interface circuitry 808.

The baseband processor circuitry 804A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The baseband processor circuitry 804A may also access group information from memory/storage 812 to determine search space groups in which a number of repetitions of a PDCCH may be transmitted.

The memory/storage 812 may include any type of volatile or non-volatile memory that may be distributed throughout the UE 800. In some embodiments, some of the memory/storage 812 may be located on the processors 804 themselves (for example, L1 and L2 cache), while other memory/storage 812 is external to the processors 804 but accessible thereto via a memory interface. The memory/storage 812 may include any suitable volatile or non-volatile memory, such as, but not limited to, dynamic random-access memory (DRAM), static random-access memory (SRAM), erasable programmable read-only memory (EPROM), electrically erasable programmable read-only memory (EEPROM), Flash memory, solid-state memory, or any other type of memory device technology.

The RF interface circuitry 808 may include transceiver circuitry and a radio frequency front end module (RF FEM) that allows the UE 800 to communicate with other devices over a radio access network. The RF interface circuitry 808 may include various elements arranged in transmit or receive paths. These elements may include, for example, switches, mixers, amplifiers, filters, synthesizer circuitry, control circuitry, etc.

In the receive path, the RF FEM may receive a radiated signal from an air interface via an antenna 850 and proceed to filter and amplify (with a low-noise amplifier) the signal. The signal may be provided to a receiver of the transceiver that down-converts the RF signal into a baseband signal that is provided to the baseband processor of the processors 804.

In the transmit path, the transmitter of the transceiver up-converts the baseband signal received from the baseband processor and provides the RF signal to the RF FEM. The RFEM may amplify the RF signal through a power amplifier prior to the signal being radiated across the air interface via the antenna 850.

In various embodiments, the RF interface circuitry 808 may be configured to transmit and/or receive signals in a manner compatible with NR access technologies.

The antenna 850 may include a number of antenna elements that each convert electrical signals into radio waves to travel through the air and to convert received radio waves into electrical signals. The antenna elements may be arranged into one or more antenna panels. The antenna 850 may have antenna panels that are omnidirectional, directional, or a combination thereof to enable beamforming and multiple input, multiple output communications. The antenna 850 may include microstrip antennas, printed antennas fabricated on the surface of one or more printed circuit boards, patch antennas, phased array antennas, etc. The antenna 850 may have one or more panels designed for specific frequency bands including bands in FR1 or FR2.

The user interface circuitry 816 includes various input/output (I/O) devices designed to enable user interaction with the UE 800. The user interface 816 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators, such as light emitting diodes (LEDs) and multi-character visual outputs, or more complex outputs, such as display devices or touchscreens (for example, liquid crystal displays (LCDs), LED displays, quantum dot displays, projectors, etc.), with the output of characters, graphics, multimedia objects, and the like being generated or produced from the operation of the UE 800.

The sensors 820 may include devices, modules, or subsystems whose purpose is to detect events or changes in its environment and send the information (sensor data) about the detected events to some other device, module, subsystem, etc. Examples of such sensors include, inter alia, inertia measurement units comprising accelerometers; gyroscopes; or magnetometers; microelectromechanical systems or nanoelectromechanical systems comprising 3-axis accelerometers; 3-axis gyroscopes; or magnetometers; level sensors; flow sensors; temperature sensors (for example, thermistors); pressure sensors; barometric pressure sensors; gravimeters; altimeters; image capture devices (for example; cameras or lensless apertures); light detection and ranging sensors; proximity sensors (for example, infrared radiation detector and the like); depth sensors; ambient light sensors; ultrasonic transceivers; microphones or other like audio capture devices; etc.

The driver circuitry 822 may include software and hardware elements that operate to control particular devices that are embedded in the UE 800, attached to the UE 800, or otherwise communicatively coupled with the UE 800. The driver circuitry 822 may include individual drivers allowing other components to interact with or control various input/output (I/O) devices that may be present within, or connected to, the UE 800. For example, driver circuitry 822 may include a display driver to control and allow access to a display device, a touchscreen driver to control and allow access to a touchscreen interface, sensor drivers to obtain sensor readings of sensor circuitry 820 and control and allow access to sensor circuitry 820, drivers to obtain actuator positions of electro-mechanic components or control and allow access to the electro-mechanic components, a camera driver to control and allow access to an embedded image capture device, audio drivers to control and allow access to one or more audio devices.

The PMIC 824 may manage power provided to various components of the UE 800. In particular, with respect to the processors 804, the PMIC 824 may control power-source selection, voltage scaling, battery charging, or DC-to-DC conversion.

In some embodiments, the PMIC 824 may control, or otherwise be part of, various power saving mechanisms of the UE 800. For example, if the platform UE is in an RRC_Connected state, where it is still connected to the RAN node as it expects to receive traffic shortly, then it may enter a state known as Discontinuous Reception Mode (DRX) after a period of inactivity. During this state, the UE 800 may power down for brief intervals of time and thus save power. If there is no data traffic activity for an extended period of time, then the UE 800 may transition off to an RRC_Idle state, where it disconnects from the network and does not perform operations, such as channel quality feedback, handover, etc. The UE 800 goes into a very low power state and it performs paging where again it periodically wakes up to listen to the network and then powers down again. The UE 800 may not receive data in this state; in order to receive data, it must transition back to RRC_Connected state. An additional power saving mode may allow a device to be unavailable to the network for periods longer than a paging interval (ranging from seconds to a few hours). During this time, the device is totally unreachable to the network and may power down completely. Any data sent during this time incurs a large delay and it is assumed the delay is acceptable.

A battery 828 may power the UE 800, although in some examples the UE 800 may be mounted deployed in a fixed location and may have a power supply coupled to an electrical grid. The battery 828 may be a lithium-ion battery, a metal-air battery, such as a zinc-air battery, an aluminum-air battery, a lithium-air battery, and the like. In some implementations, such as in vehicle-based applications, the battery 828 may be a typical lead-acid automotive battery.

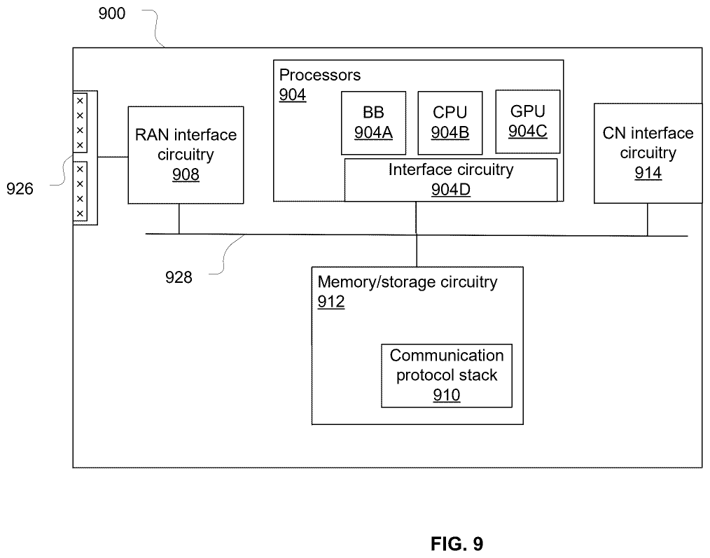

FIG. 9 illustrates a gNB 900, in accordance with some embodiments. The gNB 900 may be similar to and substantially interchangeable with the base station 108 of FIG. 1 and other base stations described herein above. Particularly, the gNB 900 can support configuration and/or processing of CSI using rank offsets, as described herein.

The gNB 900 may include processors 904, RAN interface circuitry 908, core network (CN) interface circuitry 912, and memory/storage circuitry 916.

The components of the gNB 900 may be coupled with various other components over one or more interconnects 928.

The processors 904, RAN interface circuitry 908, memory/storage circuitry 916 (including communication protocol stack 910), antenna 950, and interconnects 928 may be similar to like-named elements shown and described with respect to FIG. 8.

The CN interface circuitry 912 may provide connectivity to a core network, for example, a Fifth Generation Core network (5GC) using a 5GC-compatible network interface protocol, such as carrier Ethernet protocols, or some other suitable protocol. Network connectivity may be provided to/from the gNB 900 via a fiber optic or wireless backhaul. The CN interface circuitry 912 may include one or more dedicated processors or FPGAs to communicate using one or more of the aforementioned protocols. In some implementations, the CN interface circuitry 912 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, network element, etc. as described above in connection with one or more of the preceding figures may be configured to operate in accordance with one or more of the examples set forth below in the example section.

### EXAMPLES

In the following sections, further exemplary embodiments are provided.

Example 1 includes method comprising: determining a first performance metric associated with a single user (SU)-multiple input multiple output (MIMO) mode and a second performance metric associated with a multiple user (MU)-MIMO mode; determining a rank offset based on a difference between the first performance metric and the second performance metric; determining a rank indicator (RI) based on the rank offset; and generating a channel state information (CSI) report for transmission, the CSI report to include the RI.

Example 2 includes the method of example 1 or some other example herein, further comprising: receiving a physical downlink shared channel (PDSCH) transmission; and detecting whether the PDSCH transmission is transmitted using the SU-MIMO mode or the MU-MIMO mode, wherein the first and second performance metrics are determined based on the detected SU-MIMO mode or the MU-MIMO mode.

Example 3 includes the method of example 2 or some other example herein, wherein detecting whether the PDSCH transmission is transmitted using the SU-MIMO mode or the MU-MIMO mode includes generating a probability that a transmission mode is the SU-MIMO mode or the MU-MIMO mode.

Example 4 includes the method of example 3 or some other example herein, wherein determining the rank offset includes applying an adjustment to a prior rank offset value based on the probability.

Example 5 includes the method of example 1 or some other example herein, wherein the rank offset is a first rank offset, and wherein the method further comprises determining a plurality of rank offsets, including the first rank offset, for respective pairs of a number of layers and a transmission mode.

Example 6 includes the method of example 5 or some other example herein, further comprising: obtaining one or more CSI measurements; and determining CSI metrics for respective candidate ranks based on the one or more CSI measurements, wherein determining the rank indicator includes: applying respective rank offsets of the plurality of rank offsets to the respective CSI metrics to generate compensated CSI metrics; and determining the rank indicator based on the compensated CSI metrics.

Example 7 includes the method of example 1 or some other example herein, wherein determining the rank offset is based further on a prior rank offset value.

Example 8 includes the method of example 7 or some other example herein, wherein determining the rank offset includes adjusting the prior rank offset value by an adjustment amount based on a physical downlink shared channel (PDSCH) grant, wherein the PDSCH grant is associated with a first candidate rank and the rank offset is associated with a second candidate rank that is a next higher rank or a next lower rank than the first candidate rank.

Example 9 includes the method of example 8 or some other example herein, wherein the adjustment amount is to increase the rank offset for the second candidate rank that is the next higher rank than the first candidate rank based on the first performance metric at the first candidate rank being better than the second performance metric at the first candidate rank.

Example 10 includes the method of example 8 or some other example herein, wherein the adjustment amount is to increase the rank offset for the second candidate rank that is the next lower rank than the first candidate rank based on the second performance metric at the first candidate rank being better than the first performance metric at the first candidate rank.

Example 11 includes the method of example 1 or some other example herein, wherein the first and second performance metrics include first and second spectral efficiencies.

Example 12 includes one or more computer-readable media having instructions, stored thereon, that when executed cause processing circuitry to: determine a transmission mode and a rank of respective downlink transmissions, wherein the transmission mode is a single user (SU)-multiple input multiple output (MIMO) mode or a multiple user (MU)-MIMO mode; determine, based on the downlink transmissions, respective performance metrics per-rank and per-transmission mode; determine rank offsets based on the respective performance metrics; apply the rank offsets to respective channel state information (CSI) metrics to generate compensated CSI metrics; determine a rank indicator (RI) to report based on the compensated CSI metrics; and generate a CSI report for transmission, the CSI report to include the RI.

Example 13 includes the one or more computer-readable media of example 12 or some other example herein, wherein the performance metrics include spectral efficiencies.

Example 14 includes the one or more computer-readable media of example 12 or some other example herein, wherein to determine the transmission mode of the respective downlink transmissions includes to determine a probability that the transmission mode is the SU-MIMO mode or the MU-MIMO mode, wherein the rank offsets are determined based on the respective probability.

Example 15 includes the one or more computer-readable media of example 12 or some other example herein, wherein to determine the rank offsets includes to determine a first rank offset based on a prior rank offset value, a first performance metric for SU-MIMO, and a second performance metric for MU-MIMO.

Example 16 includes the one or more computer-readable media of example 15 or some other example herein, wherein the first and second performance metrics are for a current rank and the rank offset is for a next higher rank.

Example 17 includes the one or more computer-readable media of example 15 or some other example herein, wherein the first and second performance metrics are for a current rank and the rank offset is for a next lower rank.

Example 18 includes an apparatus comprising processing circuitry to: detect a transmission mode of a physical downlink shared channel (PDSCH) grant, wherein the transmission mode is a single user (SU)-multiple input multiple output (MIMO) mode or a multiple user (MU)-MIMO mode; determine a first spectral efficiency of SU-MIMO and a second spectral efficiency of MU-MIMO; update a rank offset associated with the detected transmission mode based on a prior rank offset value, the first spectral efficiency, and the second spectral efficiency; and determine a rank indicator (RI) to report to a network based on the rank offset. The apparatus may further include interface circuitry coupled to the processing circuitry to enable communication.

Example 19 includes the apparatus of example 18 or some other example herein, wherein to detect the transmission mode includes to detect a probability that the transmission mode is the SU-MIMO mode or the MU-MIMO mode.

Example 20 includes the apparatus of example 18 or some other example herein, wherein the first and second spectral efficiencies are for a current rank and the rank offset is for a next higher rank or the next lower rank.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
determining a first performance metric associated with a single user (SU)-multiple input multiple output (MIMO) mode and a second performance metric associated with a multiple user (MU)-MIMO mode;
determining a rank offset based on a difference between the first performance metric and the second performance metric;
determining a rank indicator (RI) based on the rank offset; and
generating a channel state information (CSI) report for transmission, the CSI report to include the RI.

2. The method of claim 1, further comprising:
receiving a physical downlink shared channel (PDSCH) transmission;
detecting whether the PDSCH transmission is transmitted using the SU-MIMO mode or the MU-MIMO mode, wherein the first and second performance metrics are determined based on the detected SU-MIMO mode or the MU-MIMO mode.

3. The method of claim 2, wherein detecting whether the PDSCH transmission is transmitted using the SU-MIMO mode or the MU-MIMO mode includes generating a probability that a transmission mode is the SU-MIMO mode or the MU-MIMO mode.

4. The method of claim 3, wherein determining the rank offset includes applying an adjustment to a prior rank offset value based on the probability.

5. The method of claim 1, wherein the rank offset is a first rank offset, and wherein the method further comprises determining a plurality of rank offsets, including the first rank offset, for respective pairs of a number of layers and a transmission mode.

6. The method of claim 5, further comprising:
obtaining one or more CSI measurements; and
determining CSI metrics for respective candidate ranks based on the one or more CSI measurements, wherein determining the rank indicator includes:
applying respective rank offsets of the plurality of rank offsets to the respective CSI metrics to generate compensated CSI metrics; and
determining the rank indicator based on the compensated CSI metrics.

7. The method of claim 1, wherein determining the rank offset is based further on a prior rank offset value.

8. The method of claim 7, wherein determining the rank offset includes adjusting the prior rank offset value by an adjustment amount based on a physical downlink shared channel (PDSCH) grant, wherein the PDSCH grant is associated with a first candidate rank and the rank offset is associated with a second candidate rank that is a next higher rank or a next lower rank than the first candidate rank.

9. The method of claim 8, wherein the adjustment amount is to increase the rank offset for the second candidate rank that is the next higher rank than the first candidate rank based on the first performance metric at the first candidate rank being better than the second performance metric at the first candidate rank.

10. The method of claim 8, wherein the adjustment amount is to increase the rank offset for the second candidate rank that is the next lower rank than the first candidate rank based on the second performance metric at the first candidate rank being better than the first performance metric at the first candidate rank.

11. The method of claim 1, wherein the first and second performance metrics include first and second spectral efficiencies.

12. One or more non-transitory, computer-readable media having instructions that, when executed, cause processing circuitry to:
determine a transmission mode and a rank of respective downlink transmissions, wherein the transmission mode is a single user (SU)-multiple input multiple output (MIMO) mode or a multiple user (MU)-MIMO mode;
determine, based on the downlink transmissions, respective performance metrics per-rank and per-transmission mode;
determine rank offsets based on the respective performance metrics;
apply the rank offsets to respective channel state information (CSI) metrics to generate compensated CSI metrics;
determine a rank indicator (RI) to report based on the compensated CSI metrics; and
generate a CSI report for transmission, the CSI report to include the RI.

13. The one or more non-transitory, computer-readable media of claim 12, wherein the performance metrics include spectral efficiencies.

14. The one or more non-transitory, computer-readable media of claim 12, wherein to determine the transmission mode of the respective downlink transmissions includes to determine a probability that the transmission mode is the SU-MIMO mode or the MU-MIMO mode, wherein the rank offsets are determined based on the respective probability.

15. The one or more non-transitory, computer-readable media of claim 12, wherein to determine the rank offsets includes to determine a first rank offset based on a prior rank offset value, a first performance metric for SU-MIMO, and a second performance metric for MU-MIMO.

16. The one or more non-transitory, computer-readable media of claim 15, wherein the first and second performance metrics are for a current rank and the rank offset is for a next higher rank.

17. The one or more non-transitory, computer-readable media of claim 15, wherein the first and second performance metrics are for a current rank and the rank offset is for a next lower rank.

18. An apparatus comprising:
processing circuitry to:
detect a transmission mode of a physical downlink shared channel (PDSCH) grant, wherein the transmission mode is a single user (SU)-multiple input multiple output (MIMO) mode or a multiple user (MU)-MIMO mode;
determine a first spectral efficiency of SU-MIMO and a second spectral efficiency of MU-MIMO;
update a rank offset associated with the detected transmission mode based on a prior rank offset value, the first spectral efficiency, and the second spectral efficiency; and
determine a rank indicator (RI) to report to a network based on the rank offset; and
interface circuitry coupled to the processing circuitry to enable communication.

19. The apparatus of claim 18, wherein to detect the transmission mode includes to detect a probability that the transmission mode is the SU-MIMO mode or the MU-MIMO mode.

20. The apparatus of claim 18, wherein the first and second spectral efficiencies are for a current rank and the rank offset is for a next higher rank or the next lower rank.
